(19) United States
(12) Patent Application Publication
(10) Pub. No.: US 2003/0227773 A1
(43) Pub. Date: Dec. 11, 2003

(54) Light device for attaching onto various objects

(76) Inventor: Chang Yao Yang, Chong Ho City (TW)

Correspondence Address: Chang Yao Yang, P.O. Box 10-69, Chong Ho, Taipei, 235, TW

(21) Appl. No.: 10/165,494

(22) Filed: Jun. 5, 2002

(51) Int. Cl. F21L 4/04

(52) U.S. Cl. 362/199

(57) ABSTRACT

A light device includes a barrel extended from a rear portion of a housing and having a bore formed in the barrel. A circuit board is received in the base, a light member is coupled to the circuit board. A clasp device includes a ball rotatably received in the bore of the barrel for rotatably attaching to the housing, and for attaching the housing to various objects. The clasp device includes a neck, the barrel includes a side passage communicating with the bore for receiving the neck. The housing is attachable to tubular members with a coupler and a clip member.

### BACKGROUND OF THE INVENTION

1. Field of the Invention

The present invention relates to a light device, and more particularly to a light device for attaching onto various kinds of objects.

2. Description of the Prior Art

Various kinds of typical flashlights or light devices have been developed for lighting or illuminating purposes. However, the flashlights or the light devices may not be easily attached onto various kinds of objects. For example, the flashlights may not be easily attached onto the clothes or the hats of the users, and/or may not be solidly attached onto the cycles.

The present invention has arisen to mitigate and/or obviate the afore-described disadvantages of the conventional light devices.

### SUMMARY OF THE INVENTION

The primary objective of the present invention is to provide a light device provided for attaching onto various kinds of objects.

The other objective of the present invention is to provide a light device provided for attaching onto the tubular members of the cycles, for allowing the cycle riders to easily and comfortably ride the cycles without holding the light device with their hands.

In accordance with one aspect of the invention, there is provided a light device comprising a housing including a base having at least one chamber formed therein, and having a front portion, and having a rear portion, the rear portion of the base including a barrel extended therefrom and having a bore formed therein, a circuit board received in the chamber of the base, a light member coupled to the circuit board and received in the front portion of the base, means for energizing the light member, means for controlling the light member, and a clasp device including a ball attached thereto and rotatably received in the bore of the barrel of the housing, for rotatably attaching the housing to the clasp device, the clasp device being provided for attaching the housing to various objects.

The clasp device includes a neck extended therefrom and having the ball provided on the neck, the barrel includes a side portion having a passage formed therein and communicating with the bore thereof for receiving the neck.

A coupler is further provided for attaching onto tubular members and includes a bracket provided thereon, and a clip member attached onto the housing and engageable onto the coupler, for attaching the housing to the coupler, and for attaching the housing to the tubular members.

The coupler includes a loop for receiving the tubular member, and a pair of ears, and means for securing the ears together.

The energizing means includes at least one battery received in the chamber of the base, the housing includes a cover attached onto the base and having an opening formed therein and aligned with the battery, and a lid attached onto the cover for blocking the opening of the cover.

Further objectives and advantages of the present invention will become apparent from a careful reading of a detailed description provided hereinbelow, with appropriate-reference to accompanying drawings.

### BRIEF DESCRIPTION OF THE DRAWINGS

FIG. 1 is a perspective view of a light device in accordance with the present invention;

FIG. 2 is a partial exploded view of the light device;

FIGS. 3, 4 are perspective views illustrating the operation of the light device;

FIG. 5 is a perspective view illustrating the operation or the attachment of the light device onto the user;

FIG. 6 is a plane schematic view illustrating the operation or the attachment of the light device onto the cycles; and

FIG. 7 is an enlarged partial plane schematic view illustrating the attachment of the light device onto the cycles.

### DETAILED DESCRIPTION OF THE PREFERRED EMBODIMENT

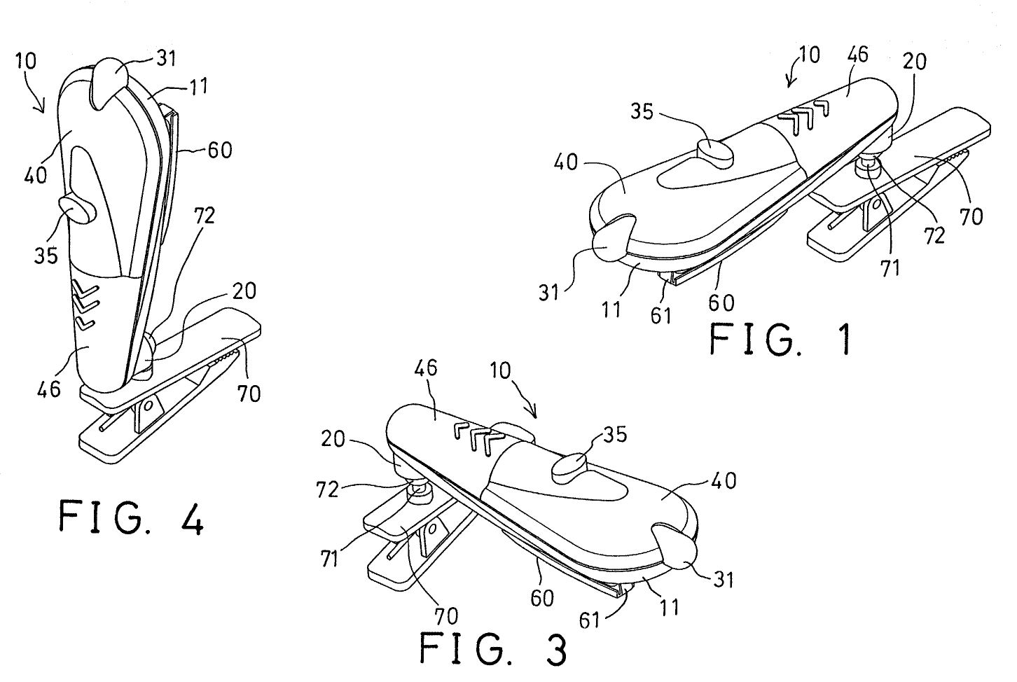

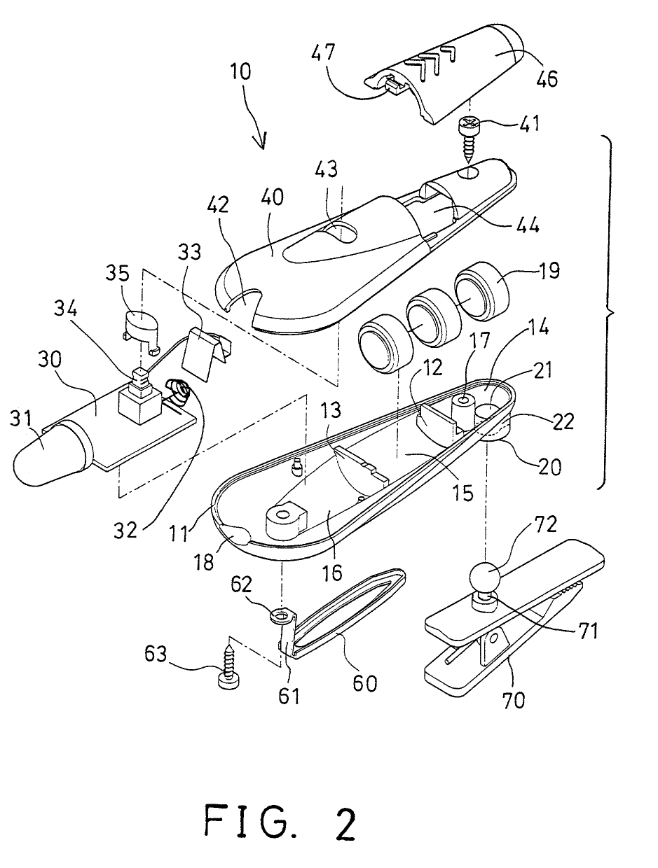

Referring to the drawings, and initially to FIGS. 1 and 2, a light device in accordance with the present invention is generally indicated with a reference numeral and comprises a housing 10 including a base 11 having one or more partitions 12, 13 extended or disposed or provided therein for forming one or more chambers 14, 15, 16 in the base 11. For example, the base 11 includes three chambers 14, 15, 16 formed in the rear and the middle and the front portions thereof respectively; and includes one or more studs 17 extended therein, and includes a notch 18 formed in the front portion thereof.

One or more batteries 19 are received in either of the chambers 14-16 of the base 11, such as received in the middle chamber 15 of the base 11, and preferably engaged or retained between the partitions 12, 13. The base 11 includes a barrel 20 extended outward or downward from the rear portion thereof, and having a bore 21 formed therein, and having a channel or a passage 22 formed in the side portion thereof and communicating with the bore 21 thereof.

A circuit board 30 is received in the base 11, such as received in the front chamber 16 of the base 11, and preferably engaged with the partition 13 so as to be stably retained in the front chamber 16 of the base 11. A light member 31, such as a light bulb, a light emitting diode, or the like, is attached to the circuit board 30, and received in the notch 18 of the base 11. A pair of conductors, such as a coil spring 32 and a conductor blade 33 are attached onto the partitions 12, 13 of the base 11, and engaged with the center and the case electrodes of the batteries 19 respectively, and coupled to the light member 31, for allowing the batteries 19 to form an energizing device or means to energize the light member 31.

A switch 34 may be attached to the circuit board 30, and coupled between the conductors 32, 33 or between the conductor 32 and the light member 31, for controlling the on and off of the light member 31. A button 35 may further be provided and engaged onto the switch 34 for allowing the users to comfortably depress or actuate the switch 34. The switch 34 and the button 35 may thus form a device or a means for controlling the light member 31. A cover 40 is engaged onto the base 11 with one or more fasteners 41 which may be engaged through the cover 40 and secured to the studs 17 of the base 11. The cover 40 includes a notch 42 and an orifice 43 formed in the front and the middle portions thereof for receiving the light member 31 and the button 35 respectively.

The cover 40 includes an opening 44 formed in the middle portion thereof, and aligned with the middle chamber 15 of the base 11, for allowing the batteries 19 to be engaged into or disengaged from the base 11, without disengaging the cover 40 from the base 11. A lid 46 is detachably secured onto the cover 40 with fasteners (not shown), or one or more latches 47, for enclosing the opening 44 of the cover 40, and for stably retaining the batteries 19 within the middle chamber 15 of the base 11.

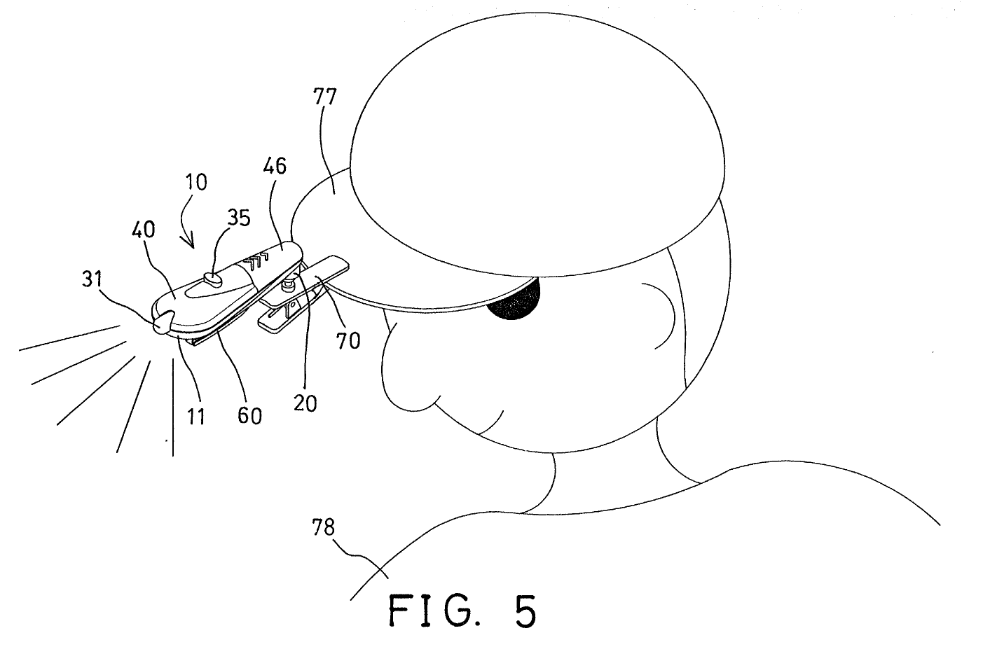

A clamp or a clasp device 70 may further be provided and may be attached onto the hat 77 or the clothes 78 of the users (FIG. 5), and includes a neck 71 and a ball 72 extended therefrom or attached thereto. The ball 72 may be rotatably received in the bore 21 of the barrel 20, for forming a universal joint, and for rotatably securing the housing 10 to the clasp device 70, and for allowing the housing 10 to be rotated relative to the clasp device 70 to any suitable angular positions, best shown in FIGS. 1 and 3. As shown in FIG. 4, the neck 71 of the clasp device 70 may be received in the passage 22 of the barrel 20 (FIG. 2), for allowing the housing 10 to be rotated to a position substantially perpendicular to the clasp device 70.

The neck 71 of the clasp device 70 includes a diameter smaller than that of the ball 72. The passage 22 of the barrel 20 also includes an inner diameter or a width smaller than that of the bore 21 of the barrel 20. The bore 21 and the passage 22 of the barrel 20 include an inner diameter or a width equals to or slightly less than that of the ball 72 and the neck 71 of the clasp device 70, for allowing the ball 72 and the neck 71 of the clasp device 70 to be snugly engaged in the bore 21 and the passage 22 of the barrel 20, and for allowing the housing 10 to be rotated and retained to any suitable angular position relative to the clasp device 70.

A clip member 60 includes an extension 61 having a ring 62 attached or provided thereon for securing to the housing 10 of the light device with one or more fasteners 63 or the like. The clip member 60 may be used for attaching the light device to the bag of the users or the like.

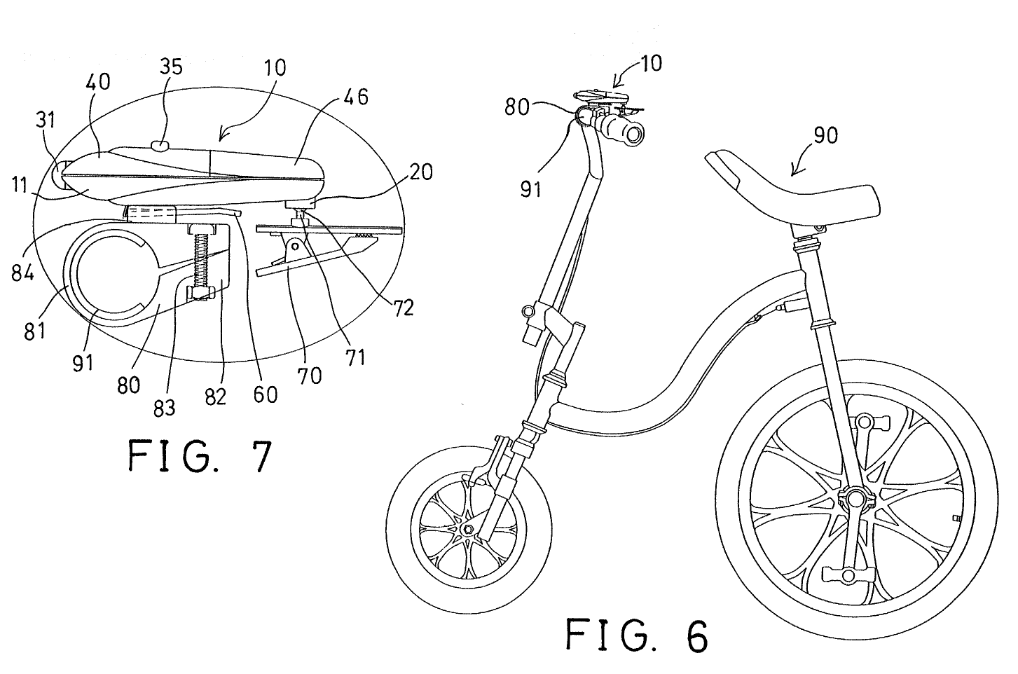

As shown in FIGS. 6 and 7, a coupler 80 may further be provided and includes a loop 81 for engaging onto a tubular member 91 of cycles 90, such as the handlebar 91 of the cycles 90, and includes two ears 82, and one or more fasteners 83 engaged through the ears 82 for solidly securing the coupler 80 onto the tubular member 91 of the cycles 90. The coupler 80 includes a bracket 84 extended or provided thereon. The clip member 60 may be engaged with the bracket 84 for attaching the housing 10 to the coupler 80, and thus for attaching the light device onto the cycles 90.

The cycle riders, particularly the children may thus more safely ride the cycles 90 during the night or in the dark environment. Particularly, the cycle riders are not required to hold the light device with their hands, such that the riders may easily or comfortably ride the cycles 90.

Accordingly, the light device in accordance with the present invention may be provided for attaching onto various kinds of objects, such as for attaching onto the tubular members of the cycles, for allowing the cycle riders to easily and comfortably ride the cycles without holding the light device with their hands.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A light device comprising:
a housing including a base having at least one chamber formed therein, and having a front portion, and having a rear portion, said rear portion of said base including a barrel extended therefrom and having a bore formed therein,
a circuit board received in said at least one chamber of said base,
a light member coupled to said circuit board and received in said front portion of said base,
means for energizing said light member,
means for controlling said light member, and
a clasp device including a ball attached thereto and rotatably received in said bore of said barrel of said housing, for rotatably attaching said housing to said clasp device, said clasp device being provided for attaching said housing to various objects.

2. The light device according to claim 1, wherein said clasp device includes a neck extended therefrom and having said ball provided on said neck, said barrel includes a side portion having a passage formed therein and communicating with said bore thereof for receiving said neck.

3. The light device according to claim 1 further comprising a coupler for attaching onto tubular members and including a bracket provided thereon, and a clip member attached onto said housing and engageable onto said coupler, for attaching said housing to said coupler, and for attaching said housing to the tubular members.

4. The light device according to claim 3, wherein said coupler includes a loop for receiving the tubular member, and a pair of ears, and means for securing said ears together.

5. The light device according to claim 1, wherein said energizing means includes at least one battery received in said at least one chamber of said base, said housing includes a cover attached onto said base and having an opening formed therein and aligned with said at least one battery, and a lid attached onto said cover for blocking said opening of said cover.
